(19) United States
(12) Patent Application Publication
(10) Pub. No.: US 2023/0138755 A1
(43) Pub. Date: May 4, 2023

(54) ELECTRONIC KNIFE SWITCH

(71) Applicant: AOB Products Company, Columbia, MO (US)

(72) Inventors: Ryan Varnum, Columbia, MO (US); Eric Smith, Columbia, MO (US); Timothy S. Kinney, Warrenton, MO (US); James Tayon, Moberly, MO (US); Aaron Wood, Columbia, MO (US); Seth Wheeler, Columbia, MO (US); Bryan Mach, Columbia, MO (US); Kyle Smith, Columbia, MO (US); Matthew Kinamore, Columbia, MO (US); Curtis Smith, Columbia, MO (US)

(73) Assignee: AOB Products Company, Columbia, MO (US)

(21) Appl. No.: 18/052,550

(22) Filed: Nov. 3, 2022

Related U.S. Application Data
(60) Provisional application No. 63/263,472, filed on Nov. 3, 2021.

(51) Int. Cl. B26B 7/00

(52) U.S. Cl. CPC B26B 7/005

(57) ABSTRACT

An electric fillet knife and components thereof. The electric fillet knife includes an electronic switch and a trigger arranged to actuate the electronic switch. The trigger and electronic switch are arranged in a compact configuration permitting reduction of a size of the handle.

### CROSS-REFERENCE TO RELATED APPLICATION

The present application claims priority to U.S. Provisional Patent App. No. 63/263,472, filed Nov. 3, 2021, which is hereby incorporated by reference in its entirety.

### FIELD

The present disclosure generally relates to electric fillet knives, and more particularly to a dual oscillating electric fillet knife.

### BACKGROUND

Electric fillet knives generally include a handle and a blade assembly. The handle may be configured to house internal electronic and mechanical components. In some electric fillet knives, the handle requires ample space for housing the components, which may render the handle bulky.

### SUMMARY

In one aspect, an electric fillet knife handle is useable with at least one knife blade. The electric fillet knife handle comprises a handle body having a rearward portion and a forward portion forward from the rearward portion. The handle body includes a gripping portion between the forward and rearward portions configured for a user to grasp the handle. A drive system comprises a blade receiver and a motor. The blade receiver is configured to receive the at least one knife blade from the forward portion of the handle body. The motor is operatively coupled to the at least one blade receiver to move the at least one blade receiver for moving the at least one knife blade with respect to the handle body. A trigger is supported by the handle body and operable to energize the motor to drive the drive system to move the blade receiver. An electronic switch is configured to be actuated by the trigger to energize the motor to drive the drive system to move the blade receiver. The electronic switch is between the at least one blade receiver and the trigger.

Other objects and features of the present disclosure will be in part apparent and in part pointed out herein.

### BRIEF DESCRIPTION OF THE DRAWINGS

FIG. 1 is a perspective of a handle of an electronic fillet knife;

FIG. 2 is an elevation of a pair of knife blades usable with the handle;

FIG. 3 is a perspective similar to FIG. 1 with a portion of the handle removed;

FIG. 4 is an enlarged fragmentary view of the perspective of FIG. 3;

FIG. 5 is an enlarged fragmentary perspective of the handle;

FIG. 6 is a left side perspective of an electronic switch cover;

FIG. 7 is a right side perspective of an electronic switch cover;

FIG. 8 is an elevation of the handle with a portion of the handle removed; and

FIG. 9 is a schematic of a control system of the electronic fillet knife.

Corresponding reference numbers indicate corresponding parts throughout the drawings.

### DETAILED DESCRIPTION

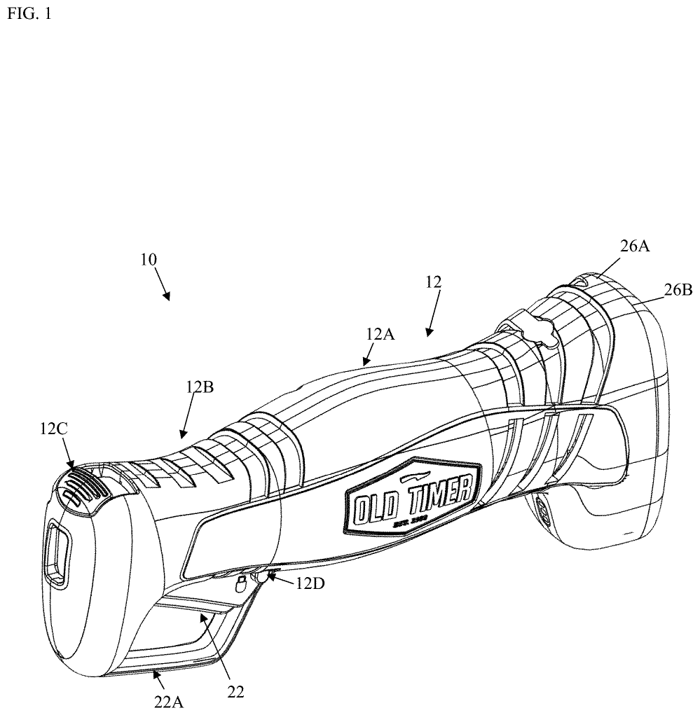

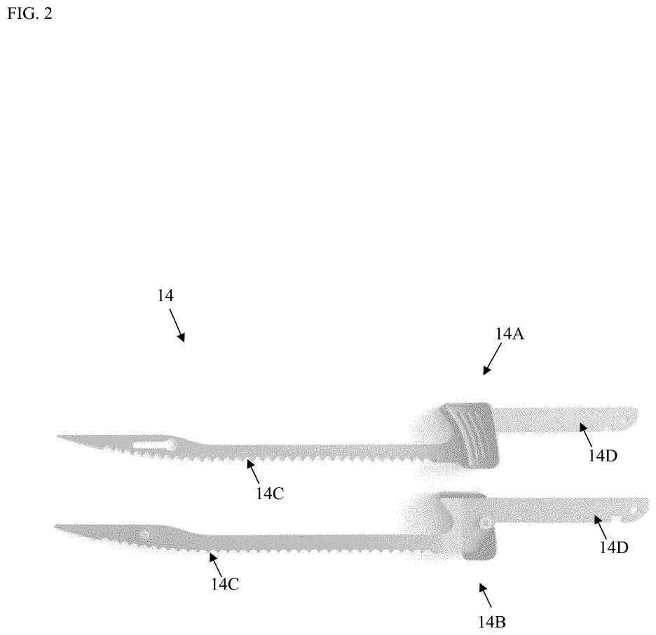

Referring to FIGS. 1 and 2, the electric fillet knife 10 (broadly, “electric knife”) can be used to cut or fillet fish. The electric fillet knife 10 includes a handle 12 and a blade assembly 14 including a pair of blades 14A, 14B. The handle defines a handle housing 12A having an interior sized and shaped for housing an electronic switch 20, a trigger 22 (broadly, electronic switch cover), and a drive system 24 (broadly, internal components). The handle 12 includes a gripping portion 12B sized and shaped to be grasped by a hand of a user.

Each blade 14A, 14B includes a cutting edge 14C and a tang 14D connected to the blade. In use, the blades move relative to each other in a reciprocating movement. Other configurations of blades (e.g. one blade) can be used without departing from the scope of the present disclosure.

The handle 12 has a rearward end portion, forward end portion, top side, and bottom side. The forward end portion of the handle 12 includes a release 12C and a safety lock 12D. The forward portion of the handle 12 also includes the gripping portion 12B, the trigger 22, and the trigger guard 22A. The handle defines a blade receiving opening at a forward end of the handle.

In the illustrated embodiment, the handle housing 12A comprises right (first) and left (second) handle housing portions 26A,26B that when connected form the handle and the handle housing more generally. Hereinafter, the right handle housing portion 26A and components thereof will be described in detail. It will be understood that the left handle housing portion comprises substantially similar complementary (mirroring) features.

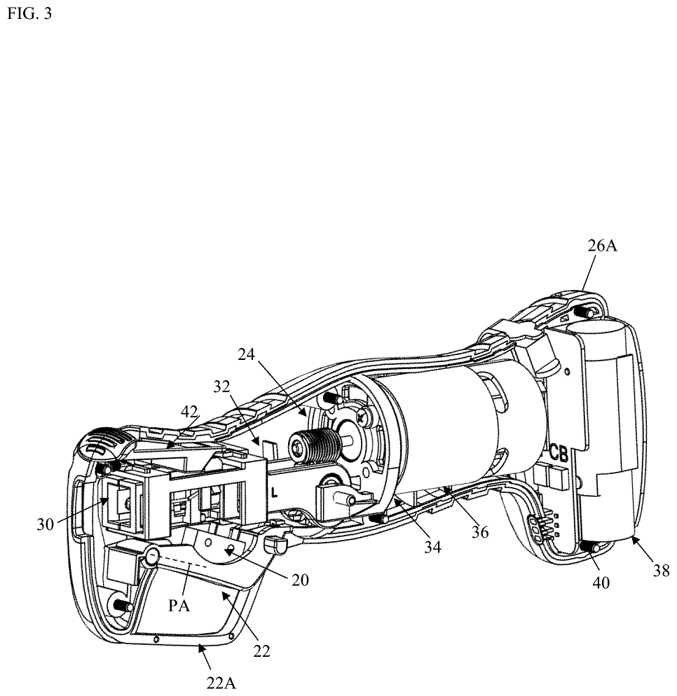

Referring to FIG. 3, the right handle housing portion 26A is sized and shaped to house the drive system 24. The drive system 24 comprises a blade receiver 30, a drive train 32, transmission 34, motor 36, which is powered by a battery 38, and wiring 40 (circuitry). Rotary motion of a motor output shaft is converted by the transmission which includes a worm gear and blade driving gear(s) (broadly, “gearing”) connected to eccentric blade drivers (broadly “linkage”) to cause the blades to move in the reciprocating motion. The blade receiver is in registration with the blade opening of the handle for receiving the blade. In the illustrated embodiment, there are two blade receivers, each configured to releasably receive the respective blades, or respective tangs of respective blades. The blade receiver includes a keeper 42 having a catch for engaging the tangs 14D to hold the blades in place during operation of the electric knife. When installed in the blade receivers, the blades define a longitudinal blade axis BA. The user can press the release 12C to disengage the catch from the keeper which will release the blade from the blade receiver. In the illustrated embodiment, the release is spring biased, however other configurations are possible.

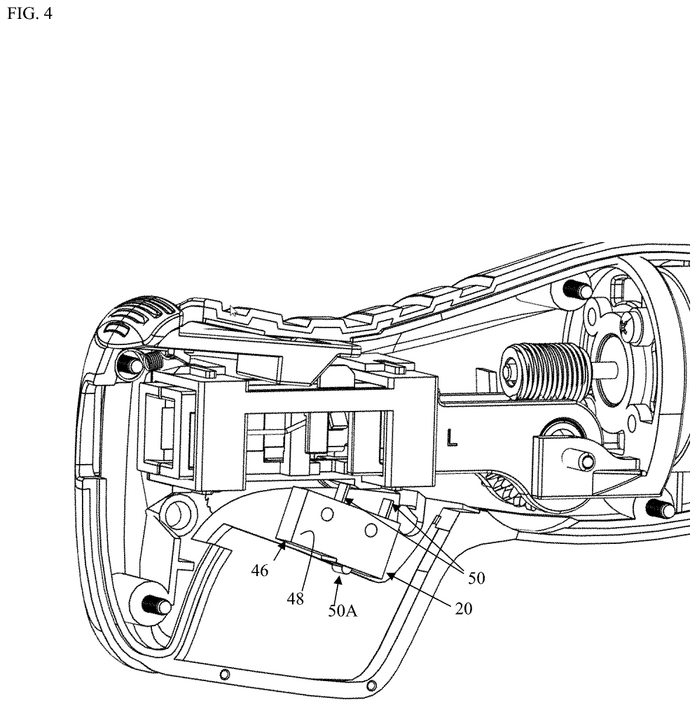

Referring to FIG. 4, the electronic switch includes an electronic switch housing 46. The electronic switch includes a pair of electrical contacts 50, a spring-biased actuator 50A, and electronic switch circuitry configured to close a circuit between the first and second contacts responsive to actuation of the spring-biased actuator by movement of the actuator into the housing 46. In the illustrated embodiment, the electronic switch 20 is generally rectangular in shape. The electronic switch body defines apertures 52 (broadly, “connectors”) connecting the electronic switch to the handle housing. However, other sizes, shapes, and arrangements of the electronic switch are possible without departing from the scope of this disclosure.

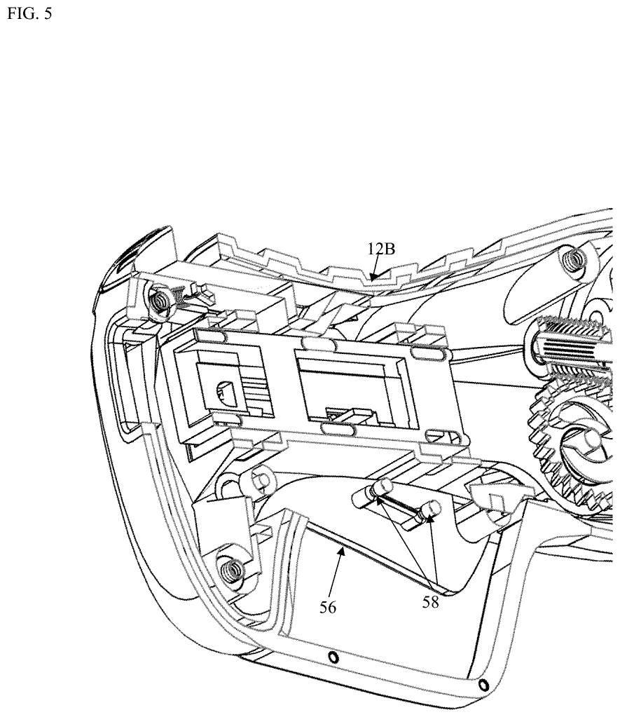

Referring to FIG. 5, a shoulder 56 (broadly, “support wall”) protrudes from the bottom side of the handle housing 12A and is sized and shaped for the electronic switch 20 to be mounted thereon. Mounts 58 (broadly, “connectors”) protrude from an interior surface of the shoulder 56 and are sized and shaped to engage with the apertures 52 of the electronic switch 20 to form a mounted connection.

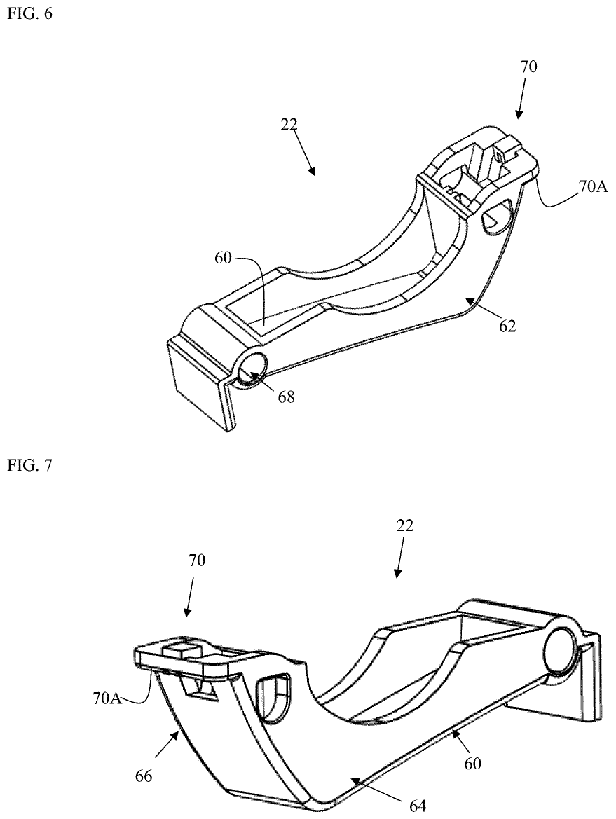

Referring to FIGS. 6 and 7, the trigger 22 comprises proximal and distal end portions, a base 60, a left (first) wall 62, a right (second) wall 64, and a rear (third) wall 66. Such walls can be generally referred to as covers or panels. The proximal end of the trigger defines an opening 68 (broadly “connector”). The opening is in registration with openings defined by the handle housing. The openings are sized and shaped to receive a fastener to form a pivot connection defining a pivot axis, PA. The base 60 of the trigger is generally rectangular and extends downwardly and distally from the pivot connection. The left wall 62 of the trigger (facing out of the page in FIG. 6) projects upward from the left edge portion of the base 60 and the right wall 64 of the trigger (facing into the page in FIG. 6) projects upward from the opposite right edge portion of the base. The left and right walls are spaced apart from each other a sufficient amount to allow the electronic switch to be received therebetween. The tops of each left and right wall define a curved edge margin, however such curvature is optional. The rearward wall 66 extends generally upwardly and distally from the distal end portion of the base 60 and connects the left and right walls 62, 64. A top portion of the end wall (distal end of the trigger) includes a retainer 70 which has an abutment surface 70A configured to abut an interior portion of the handle housing. The exterior of the base 60 is configured to receive the finger of the user. In the illustrated embodiment, together the base 60, and the left, right, and rear walls 62, 64, 66 form an enclosure for enclosing the electronic switch 20 (FIG. 3). Other configurations can be used without departing form the scope of the present disclosure. For example, other types of triggers or electronic switch covers can be used. Moreover, other trigger connections (e.g. sliding connection rather than pivoting connection) are possible without departing from the scope of this disclosure.

In the illustrated embodiment, the trigger 22 is configured to pivot about the pivot axis PA to move between at rest and operational positions. FIG. 3 illustrates the trigger in the at rest positon in which the actuator 50A is spring biased partially outboard of the electronic switch housing and presses downward on the base 60 of the trigger. When the trigger is in the at rest position, the abutment surface 70A is in contact with the interior of the handle housing to retain to trigger in the at rest position. The user may apply pressure (by squeezing) to the exterior of the base 60 of the trigger by pulling generally upward on the exterior of the base to move the trigger to the operational position. In the operational position, the interior of the base engages the actuator 50A which activates the circuitry within the electronic switch housing which energizes the motor to oscillate the blades. The actuator 50A may act as a spring biased plunger movable upward to close the circuitry. The retainer 70 is free to move slightly upward in the handle housing 12A to permit the trigger to move to the operational position. In the illustrated embodiment, there is a direct relationship between the pressure applied on the trigger (displacement of the trigger with respect to the at rest position) and the speed in which the blades oscillate.

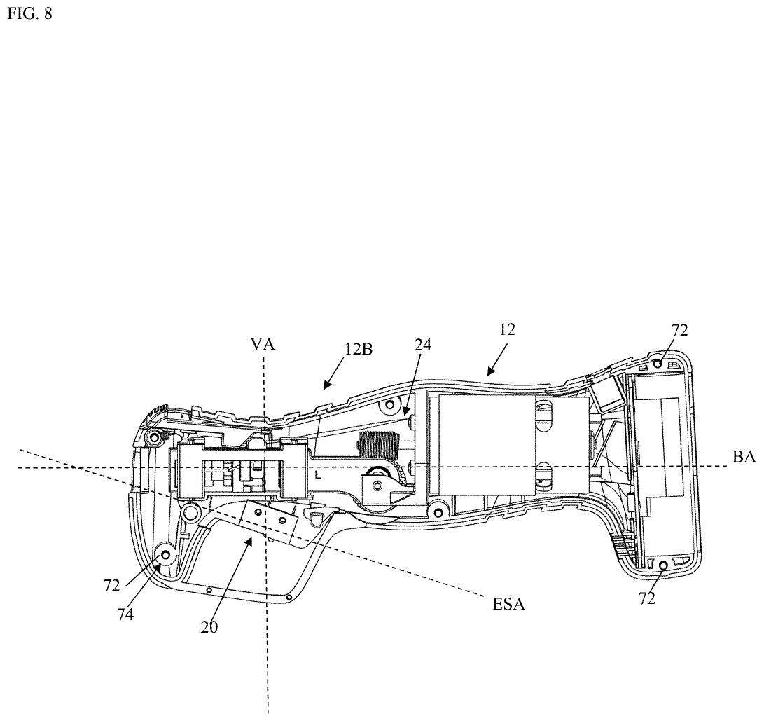

Referring to FIG. 8, the electronic switch is mounted at a skew angle with respect to the blade axis, BA. The electronic switch extends in an electronic switch plane ESA which intersects the blade axis BA at a skew angle. Moreover, a vertical plane VA extends through the electronic switch transverse to the blade axis BA. The vertical plane VA lies inboard of the opening of the handle and a rearward portion of the drive system. The vertical plane intersects the gripping portion 12B of the handle 12. The arrangement is such that the user's hand will be substantially intersected by the vertical plane VA when the user grasps gripping portion 12B.

Openings 72 are defined around the periphery of each left and right handle housing to receive fasteners 74 to connect the left and right handle housings together to form the handle 12. It will be appreciated that the location of the electronic switch allows for the internal components to occupy less space within the handle housing which allows in part for an improved compact ergonomic design of the handle.

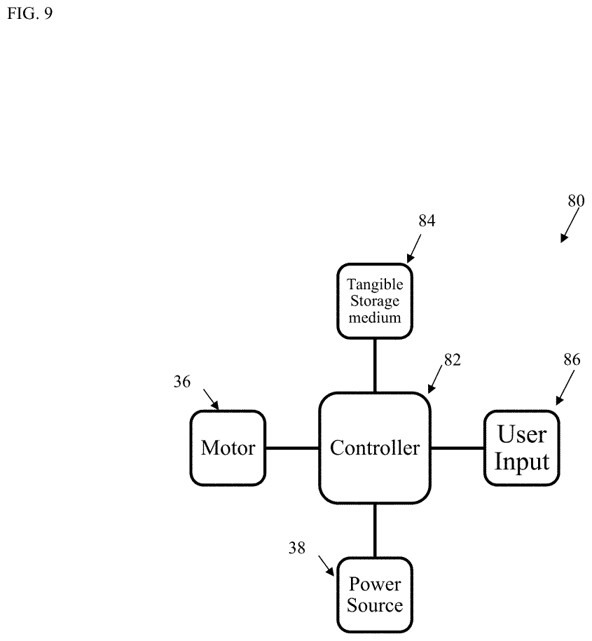

FIG. 9 illustrates a schematic of a control system 80 of the electric fillet knife 10 including one or more of the following components: a controller 82 (e.g., processor), a motor 36, a power source 38 (e.g., one or more batteries), a tangible storage medium 84, and a user input 86. The controller 82 and tangible storage medium 84 could be embodied as single board computer including a circuit board, microprocessor(s), memory, input/output, and other devices, or other suitable constructions. For example, the tangible storage medium 84 can store instructions to energize the motor 36 in response to the user input 86. In the illustrated embodiment, the user input 86 comprises the trigger 22. The controller 82 is configured to read and execute instructions stored in the storage medium 84, and is responsive to the user input 86, to control operation of the electric fillet knife 10.

It will be apparent that modifications and variations are possible without departing from the scope of the invention defined in the appended claims. The dimensions and proportions described herein are by way of example without limitation. Other dimensions and proportions can be used without departing from the scope of the present disclosure.

As various changes could be made in the above constructions and methods without departing from the scope of the invention, it is intended that all matter contained in the above description and shown in the accompanying drawings shall be interpreted as illustrative and not in a limiting sense.

What is claimed is:

1. An electric fillet knife handle useable with at least one knife blade, the electric fillet knife handle comprising:
a handle body having a rearward portion and a forward portion forward from the rearward portion, the handle body including a gripping portion between the forward and rearward portions configured for a user to grasp the handle;
a drive system comprising a blade receiver and a motor, the blade receiver being configured to receive the at least one knife blade from the forward portion of the handle body, the motor being operatively coupled to the at least one blade receiver to move the at least one blade receiver for moving the at least one knife blade with respect to the handle body;
a trigger supported by the handle body and operable to energize the motor to drive the drive system to move the blade receiver; and
an electronic switch configured to be actuated by the trigger to energize the motor to drive the drive system to move the blade receiver, wherein the electronic switch is between the at least one blade receiver and the trigger.
